(19) United States
(12) Patent Application Publication
(10) Pub. No.: US 2022/0284372 A1
(43) Pub. Date: Sep. 8, 2022

(54) Organizational Health Score Indicators and Platform

(71) Applicant: Sociometric Solutions, Inc., Boston, MA (US)

(72) Inventors: Taemie Jung Kim, Palo Alto, CA (US); Rowana Ahmed, Cambridge, MA (US); Kwok Sing Chan, South San Francisco, CA (US); Douglas Othon Issichopolous, Woodside, CA (US); Aruembora Kang, San Jose, CA (US); Kee Seon Nam, Santa Clara, CA (US); Talha Oz, San Jose, CA (US)

(21) Appl. No.: 17/189,919

(22) Filed: Mar. 2, 2021

(51) Int. Cl. G06Q 10/06; G06Q 10/10; G06Q 50/00; G06F 16/2455

(52) U.S. Cl. CPC G06Q 10/06393; G06Q 10/1091; G06Q 10/105; G06Q 10/06398; G06Q 50/01; G06F 16/24556

(57) ABSTRACT

Embodiments provide organization monitoring. An embodiment scores behavioral indicators for members of an organization by processing received time allocation data and attention minutes data to determine a value for each of a plurality of objective measures for the members. Metric scores for the members are assigned for each of the plurality of objective measures by comparing the determined value for each of the plurality of objective measures to respective benchmark values for each of the plurality of objective measures. Scores are determined for the members for each of a plurality of behavioral indicators by aggregating one or more assigned metric scores. In turn, scores for the plurality of behavioral indicators are aggregated to determine a respective score for each of a plurality of organization characteristics for the given organization. The scores for the organization characteristics are used to create a health score for the organization indicative of company culture.

### BACKGROUND

Historically, organizations base decisions on tribal knowledge, industry “best practices,” organizational charts, and subjective employee surveys. Making decisions based on subjective information, anecdotal knowledge, or gut instinct is no longer acceptable. Poor organizational health can cost organizations and companies millions of dollars by causing confusion among departments and roles, disrupting collaboration, and slowing down decision-making.

### SUMMARY

There exists a need to determine organization health (i.e., company or enterprise internal well-being), and ultimately, actions to take, using objective measures of an organization's activities, e.g., communication and interaction activity of an organization's members. Embodiments provide such functionality (determination of organization health or enterprise internal well-being indicative of company culture).

One such embodiment provides an organization monitoring method. The method aggregates, in a database, time allocation data and attention minutes data for a plurality of people at a plurality of organizations. The time allocation data and attention minutes data may be from the recent past or historical in nature for non-limiting example. This aggregated time allocation data and attention minutes data is processed or quantitatively analyzed to determine a respective benchmark value for each of a plurality of objective measures. In this way, the method determines benchmark values for objective measures of organization activities across multiple organizations.

An embodiment of the method continues by receiving time allocation data and attention minutes data (which may be current or recent data) for members of a given organization, i.e., an organization being evaluated. The received time allocation data and attention minutes data of the given organization is typically not part of the data aggregated in the database, but in some embodiments, may be. In turn, behavioral indicators for each member in a subset of the members of the given organization are scored. This scoring may include processing (quantitatively analyzing) the received, e.g., current, time allocation data and attention minutes data of the given organization to determine a value for each of the plurality of objective measures for each member in the subset. Moreover, a metric score for each member in the subset is assigned for each of the plurality of objective measures by comparing the determined value for each of the plurality of objective measures to the determined respective benchmark value for each of the plurality of objective measures. According to an embodiment, the determined value for a given objective measure is a unitless metric value. To continue, one or more assigned metric scores are aggregated to determine a respective score for each of a plurality of behavioral indicators for each member.

The preceding functionality determines scores for behavioral indicators of members of the organization being examined, i.e., evaluated to determine corrective or improvement actions to take. In an embodiment, the overall organization is then evaluated by aggregating one or more of the respective scores for the plurality of behavioral indicators of the members in the subset to determine a respective score for each of a plurality of organization characteristics for the given organization. Such an embodiment also processes (quantitatively analyzes) the respective scores for each of the plurality of organization characteristics to create a health score (overall well-being measurement) for the given organization.

According to an embodiment, processing (quantitatively analyzing) the aggregated time allocation data and attention minutes data to determine benchmark values further comprises excluding one or more subsets of the aggregated data from consideration in determining the respective benchmark value(s). In such an embodiment, one or more subset of the aggregated data can be excluded based upon at least one of: a length of time over which data in a subset was collected and characteristics of a person associated with data in a subset, amongst other examples. Another example embodiment determines each member in the subset of members of the organization being evaluated. Such an embodiment may determine members of the subset based upon at least one of: (i) a length of time for which data associated with a member exists and (ii) characteristics of a member.

When evaluating an organization, an example embodiment aggregates the one or more assigned metric scores to determine a respective score for each of a plurality of behavioral indicators. In an embodiment, this aggregating includes, for a given behavioral indicator, mathematically or quantitatively processing the one or more assigned metric scores using a function (or algorithm) specific to the given behavioral indicator to determine the respective score.

The given organization evaluated by embodiments can encompass one or more work environments. Further, in embodiments, the health score is an actionable indication of the given organization's culture. As such, an example embodiment may further include: (a) assessing the health score for the given organization to determine an actionable event, and (b) providing an indication (output indicia) of the determined actionable event to a user and/or initiating the determined actionable event. Another embodiment compares the health score to a threshold and sends an alert to a user based on results of the comparing. Embodiments may also cause an action to occur automatically based upon a determined health score. For example, an embodiment, in conjunction with other systems, may cause the creation of 1:1 (one on one) meetings (i.e., perform electronic scheduling and calendaring) with employees and their managers for groups with low management-access or provide extra vacation days for groups that have a low work-life score. Yet another embodiment, in response to determining a health score, automatically modifies a computing system to provide additional tools and allocate more resources to, for example, facilitate communication and improve work efficiency for an organization with a low health score.

In embodiments, objective measures may include at least one of: typical workday, typical weekend, focus time, focus time availability, meeting size, meeting duration, behavioral diversity, network diversity, Weak Connections, Secondary Connections, core connections, management collaboration, management access, teamwork concentration, cross-level collaboration, response time, collaborator proximity, communications worker, network elasticity, behavioral elasticity, and knowledge-transfer speed, amongst other examples. According to another embodiment, behavioral indicators include at least one of: work-life, exploration, social support, support network, efficiency, alignment, meeting culture, virtual impact, flexibility, and organizational flatness, amongst other examples. In an embodiment, behavioral indicators can include any characteristic or data point that can be considered as effecting an organization. For instance, in an embodiment, the organization characteristics include at least one of: engagement, productivity, and adaptability, amongst other examples.

Yet another embodiment is directed to an organization monitoring system. In one such embodiment, the system includes a processor and a memory with computer code instructions stored thereon. The processor and the memory, with the computer code instructions, are configured to cause the system to implement any method embodiments or combination of method embodiments described herein.

Another embodiment is directed to a computer program product for organization monitoring. The computer program product includes one or more non-transitory computer-readable storage devices where program instructions are stored on at least one of the one or more storage devices. When the program instructions are loaded and executed by a processor, the program instructions cause an apparatus associated with the processor to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flowchart of an organization monitoring method according to an embodiment.

FIG. 2 is a flowchart illustrating data flow of a method for evaluating an organization according to an embodiment.

FIG. 3 is a wheel diagram illustrating indicators and metrics that may be utilized in determining organization health according to an embodiment.

FIG. 4 is a simplified block diagram of a computer system for monitoring an organization according to an embodiment.

FIG. 5 is a simplified diagram of a computer network environment in which embodiments of the present invention may be implemented.

### DETAILED DESCRIPTION

A description of example embodiments follows.

As more and more people, e.g., knowledge workers, use digital media to do (perform) their individual and collaborative work, the logs of user systems (computing devices) can be aggregated and the data analyzed to understand a big chunk of employee workdays. In U.S. Patent Publication No. 2020/0042928 A1, the contents of which are incorporated herein by reference, functionality is described that measures objective quantified behavioral metrics and collaboration metrics of employees in an enterprise. The behavioral metrics may include time allocation data, e.g., an indication of how a person (individual employee) is spending his or her time. The collaboration metrics may include attention minutes data, e.g., an indication of how employees are interacting.

Embodiments of Applicant's described herein provide methods and systems that can use the above such metrics, collected over a period of time from a number of people, in a number of enterprises (organizations), to create a benchmark of behaviors. In turn, individual employee and group values for various indicators, e.g., objective measures of an employee or group of employees, are compared to the created benchmarks to determine if the absolute values or the distribution of values among the group members are significantly different from expected values. In addition, outcomes of these comparisons are used as factors for determining base indicators of organizational health (company internal well-being). An embodiment uses a plurality of these base indicator values to identify “high risk” areas of the organization (either individual or pockets (subsets) of employees) which are summarized through an overall numerical score.

Embodiments provide a computer-implemented method and platform/system that easily allows employee behavioral metrics to be incorporated into indicators that alert an organization, indicate an action to take, and/or automatically cause implementation (performance) of an action. In embodiments, indicators cover a wide range of areas related to organizational health (company internal well-being), and are designed to alert when an employee or certain group of employees are showing atypical behavior(s).

Embodiments can employ a database of organizational health metrics (which may be referred to herein as “component metrics” or “objective measures”) for many companies, i.e., organizations, enterprises, and the like. The database of organization health metrics may be pre-processed so that data from a plurality of organizations is prepared (i.e., formatted, normalized, etc.) and ready to be used to determine health of an individual organization, for instance, by comparing data for the individual organization to the data from the plurality of organizations in the database. This prep-work (preprocessing) may include calculating benchmark distributions for component metrics using representative companies' data. This representative data may also be processed so as to only include data from valid dates and people. In addition to date and people, embodiments may also exclude data based upon other characteristics or criteria.

Additional prep-work (preprocessing) may also include creating a framework to monitor an organization, e.g., a score framework (OHS (organization health score)→Focus Areas→Indicators→Component Metrics). In such a framework, component metrics are direct measures of work behavior (as explained in U.S. Patent Publication No. 2020/0042928 A1). In an embodiment, the framework compares the component metrics against a global benchmark to see what percentile the employee/groups are in the global benchmark population. These percentile values can be input into indicator calculations which, through a mathematical formula, combine multiple percentile values into a single indicator score. The framework can average the indicator scores within focus area categories (with some penalty on having lower values). Then, finally, the framework averages the focus area scores with some penalty on having lower values to calculate the overall OHS.

As part of monitoring an organization, an example embodiment calculates a score, i.e., an organization health score (OHS), for people (employees) in a company for a given date range. Such an embodiment determines which people (employees) to include in the OHS calculation, i.e., which employee's data to consider when determining the OHS. Next, for the determined employees, their percentiles for each component metric are determined based on the component metric's benchmark distribution. That is, for a given employee, his percentile score for each component metric is determined based on the component metric's benchmark distribution. The individual employee's percentile scores per component metric are combined across component metrics to calculate the employee's behavioral indicator score. In turn, for a group of employees, the behavioral indicator scores of respective employee members in the group are aggregated to form a behavioral indicator score distribution. Then, the distribution of the individual scores are compared to the expected distribution of the global benchmark. For example, if there are more than expected individuals with high scores the group score will be high. The absolute value of an individual score does not affect the group score. Multiple indicators may belong to a focus area. The score of the focus area is the combined group behavioral indicator scores of the indicator scores (i.e., the combination of the respective group behavioral indicator scores of each group). In an embodiment, focus area scores are calculated per group. A group can be a team, e.g., 5 people, or an office location, or can be a whole organization. In an embodiment, a focus area score is determined by looking at the distribution of individual scores within the group members. The combination or sum of focus area scores across all focus areas forms the overall organization health score (OHS) of the subject group. If the selected group includes all employees of an organization, the overall OHS is generated for the whole organization being monitored. In this way, the score framework has individual employee indicator scores at the component metric level, group indicator scores based on plural employee indicator scores, focus area scores based on group indicator scores, and the overall OHS based on the sum of all focus area scores.

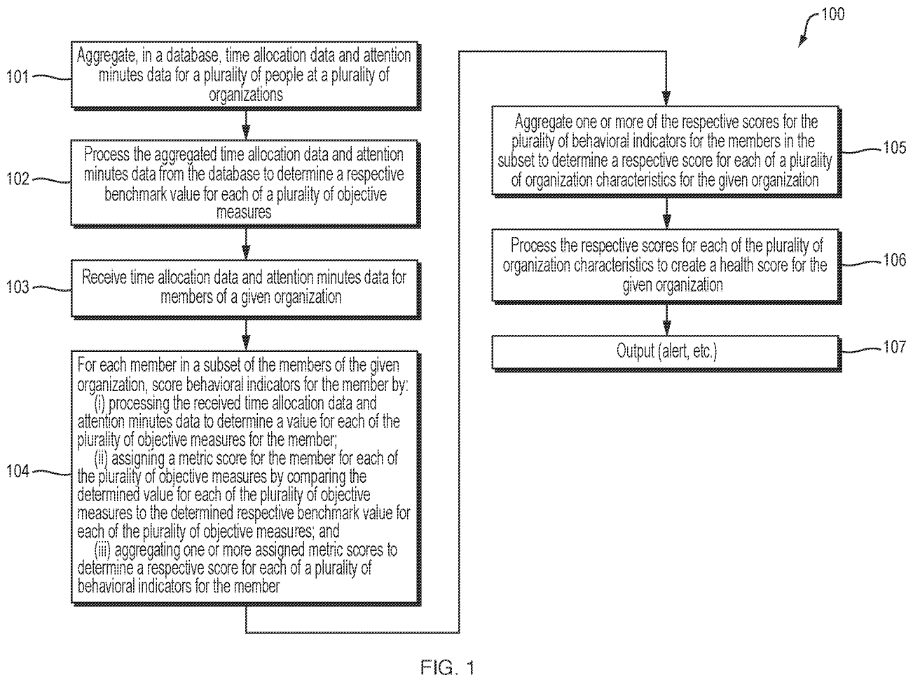

FIG. 1 is a flowchart of a computer implemented method 100 for monitoring an organization according to an embodiment. The method 100 may be implemented using any computing device or combination of computing devices known in the art.

The method 100 starts at step 101 by aggregating, in a database (or any other computer based storage medium known in the art), time allocation data and attention minutes data for a plurality of people at a plurality of organizations. As such, step 101 creates a database of data that shows how individuals across a plurality of organizations, i.e., companies, spend their time and interact. According to an embodiment, time allocation data indicates what individuals are doing at a per person, per minute, level of granularity, and attention minutes data indicates how individuals are interacting at a per pair (person-to-person), per minute, level of granularity. In an embodiment of the method 100, the time allocation data is any data that indicates how a person is spending his or her time. Similarly, in embodiments of the method 100, the attention minutes data can be any data that indicates how a person is interacting with others. In an embodiment, the time allocation data and attention minutes data aggregated at step 101 is derived from electronic communication data, e.g., email data and calendar data, amongst other examples. An example embodiment of the method 100 utilizes time allocation and attention time, e.g., minutes, determined from electronic communication data as described in U.S. Patent Publication No. 2020/0042928 A1, the contents of which are herein incorporated by reference.

To continue, at step 102 of the method 100, the time allocation data and attention minutes data, aggregated in the database at step 101, is analyzed and processed to determine a respective benchmark value for each of a plurality of objective measures. According to an embodiment, the determined benchmark values are benchmark distributions which indicate an expected distribution for each objective measure. Embodiments of the method 100 determine benchmark values, e.g., distributions, for objective measures of organization activities using data from multiple organizations. To illustrate the processing at step 102, consider a simplified example where the aggregated data indicates that person A at company X worked 7 hours each day for the week of interest and person B at company Y worked 7.5 hours each day for the week of interest. At step 102, this aggregated data is processed to determine a benchmark, e.g., the average, value of 7.25 hours per day for workday span. To illustrate another embodiment where the determined benchmark value is a distribution, at step 102 it is determined from a plurality of data points on workday span that 10% of all workdays are less than 6.9 hours and 20% of all work days are less than 7.2 hours. This processing is performed for any one or more objective measures of interest and, in this way, at step 102 a benchmark value, e.g., expected distribution, is determined for each objective measure.

According to an embodiment of the method 100, processing the aggregated time allocation data and attention minutes data at step 102 further comprises excluding a subset of the aggregated data in determining the respective benchmark value for each of the plurality of objective measures. In such an embodiment, the subset of the aggregated data can be excluded based upon one or more criteria. Example criteria for excluding data include: a length of time over which data in the subset was collected, and characteristics of a person associated with data in the subset, amongst other examples. Likewise, the processing at step 102 may also include the data validation functionality described hereinbelow under the heading “Data Validation (Inclusion Criteria).”

According to an embodiment of the method 100, objective measures may include at least one of: typical workday span, typical weekend (weekend time allocation), focus time, focus time availability, focus/transition ratio, meeting size, meeting duration, meeting type ratio, communication volume, synchronous communication ratio, meeting volume, distance to meeting rooms, behavioral diversity, network diversity, virtual meeting ratio, Weak connections, Secondary Connections, Core connections, management collaboration/access, teamwork concentration, concentration, cross-level communication, response time, collaborator proximity, communications worker, network elasticity, behavioral elasticity, and knowledge-transfer speed, amongst other examples.

Returning to FIG. 1, the method 100 continues at step 103 by receiving time allocation data and attention minutes data for members of a given organization, i.e., an organization being examined. In an embodiment, the data received at step 103 may be current or recent data. The data may be received at step 103 from any point communicatively coupled to a computing device implementing the method 100, and the data may be received via any method of communication known in the art. Moreover, the data received at step 103 may be stored at step 103 using any method of data storage known in the art. The data received at step 103 may be pre-processed, filtered, and the like to include or exclude data based upon user criteria. For instance, data may be included or excluded using the data validation functionality described hereinbelow under the heading “Data Validation (Inclusion Criteria).”

To continue, at step 104 behavioral indicators are scored for each member in a subset of the members of the given organization. The subset of members may include all members, e.g., employees, of the organization, or a particular group of members of the organization. In an embodiment, the members in the subset of interest may be based upon any user desired criteria. For instance, an embodiment may only score the behavioral indicators for members who have been employed for a certain period of time. At step 104, an example embodiment determines each member in the subset of the members of the given organization based upon at least one of: (i) a length of time for which data associated with a member exists, and (ii) characteristics of a member. Moreover, in yet another embodiment, the subset of interest may only include members for which data exists that is in compliance with user defined criteria. For instance, the data validation functionality described herein may be used, and the subset of interest may only include members who have data that complies with the data validation testing. According to another embodiment, the behavioral indicators scored at step 104 include at least one of: work-life, exploration, social support, efficiency, alignment, meeting culture, virtual impact, flexibility, and organizational flatness, amongst other examples. Further, it is noted that embodiments may utilize any desired behavioral indicators and, as such, embodiments may consider any characteristics that indicate properties, e.g., health, of an organization, as behavioral indicators.

The scoring at step 104 first processes the time allocation data and attention minutes data received at step 103 to determine a value for each of the plurality of objective measures for each member (employee) in the subset of interest. To illustrate, consider a simplified example where the time allocation data and attention minutes data received at step 103 is processed (analyzed) to determine that employee-A has a workday span of 7.5 hours per day, communicates 2 hours per weekend, and spends 25 minutes with her manager per day, while employee-B has a workday span of 7 hours per day, communicates 30 minutes per weekend, and spends 30 minutes with her manager per day. According to an embodiment, the determined value for a given objective measure is a unitless metric value, i.e., a percentile value compared to a global benchmark, i.e., a distribution determined at step 102. In an embodiment, a value for each objective measure, e.g., average workday span of 7 hours, is converted to a percentile value by comparing the metric value against the global distribution, e.g. 7 hours of workday span could be the bottom 40 percentile of the distribution. Once all of the metrics are converted to percentile values, those percentile values are mapped into a mathematical model (e.g. linear or polynomial function) that creates the overall unitless indicator score.

To continue, the scoring at step 104 assigns a metric score to each of the plurality of objective measures, for each member (employee) in the subset of interest. The metric scores are assigned by comparing the determined value for each of the plurality of objective measures to the respective benchmark value, e.g., distribution, (determined at step 102) for each of the plurality of objective measures. In other words, at this stage of step 104, each employee's (subset member's) objective measure values are compared to benchmark objective measure values and a metric score is assigned to each of the objective measures, for the employee, based on this comparison.

To illustrate, consider an example where the benchmark values determined at step 102 indicate that across multiple organizations, the average workday is 7.6 hours and use the aforementioned example where employee-A works 7.5 hours per day and employee-B works 7 hours per day. In this simplified example, metric scores of 0.42 and 0.40 are assigned for the workday span metric for employee-A and employee-B, respectively. These metric scores are determined by comparing the 7.5 hour and 7 hour work days of employee-A and employee-B to the distribution of workday bench mark values. In this example, the comparison is a percentage of the benchmark distribution that is below the particular employee's workday length value.

Scoring at step 104 concludes by aggregating one or more assigned metric scores to determine a respective score for each of a plurality of behavioral indicators for each member (employee). For instance, step 104 combines one or more metric scores to determine a score for behavioral indicators of an individual employee. In an example embodiment aggregating the one or more assigned metric scores to determine a respective score for each of a plurality of behavioral indicators includes, for a given behavioral indicator, summing or adding together the one or more assigned metric scores using a function specific to the given behavioral indicator to determine the respective score. As such, embodiments may use any variety of functions to aggregate metric scores to determine behavioral indicator scores. To illustrate, consider a simplified example where a behavioral indicator is work-life. To determine a score for work-life, the function [(average workday span percentile*5)+(weekend hours percentile*2)]/7=overwork score is used. This function aggregates average workday span and weekend hours worked (counting weekend hours as double) to determine a score for the work-life indicator. Other weighted sums or summing-like functions are suitable.

Through the aforementioned operations of step 104, respective scores for a plurality of behavioral indicators are determined for each member (employee) in the subset of interest. To illustrate, if the subset includes employee-A and employee-B and the behavioral indicators include overwork and efficiency, the scores in Table 1 are determined through the scoring calculations of step 104 of the method 100.

TABLE 1
Behavioral Indicator Scores

Behavioral Indicators

| Employee | Overwork | Efficiency |
|---|---|---|
| A | 0.7 | 0.9 |
| B | 0.8 | 0.9 |

Another embodiment of the method 100 also aggregates individual behavioral indicator scores to determine behavioral indicator scores for a group of people. These group behavioral indicator scores may then be used in the same way as individual scores in steps 105 and 106. Moreover, it is noted that in an embodiment of the method 100, the scoring operations and functionality at step 104 utilizes the techniques described hereinbelow under the headings “Evaluating Metric Amongst Global Distribution (Percentiles),” “Evaluating Behavioral Indicators,” and “Calculating Group Scores From Individuals' Scores.”

Step 104 determines scores for behavioral indicators for individual members, i.e., employees (or groups of employees) of the organization being evaluated. The method 100 continues and, at step 105, the overall organization is evaluated by aggregating one or more of the respective scores for the plurality of behavioral indicators for the members in the subset to determine a respective score for each of a plurality of organization characteristics for the given organization. According to an embodiment, the organization characteristics include at least one of: engagement, productivity, and adaptability, amongst other examples. To illustrate step 105, consider the example where employee-A has an overwork score of 0.7 and employee-B has an overwork score of 0.8. In such an example embodiment, at step 105, these scores are aggregated to create a distribution that is compared against a global distribution of the overwork metric to determine an engagement score of 9.0. In this example, both group members have a lower than median percentile in the global distribution, making the group distribution lower than expected. In a similar way, scores for other organization characteristics are also determined at step 105.

To continue, at step 106 the respective scores for each of the plurality of organization characteristics are processed (quantitatively analyzed) to create a health score for the given organization. To illustrate, if at step 105, a score is determined for the behavioral indicators, engagement, productivity, and adaptability, these scores are processed, e.g., averaged, at step 106 to determine an overall score for the organization.

Moreover, it is noted that in an embodiment of the method 100, the functionality at steps 105 and 106 may utilize the techniques described hereinbelow under the heading “Aggregate Multiple Components To Determine Higher-Level Score.” Further, it is noted that the various examples described in relation to FIG. 1 are simplified examples for purposes of illustrating the operations (computations) and functionality of the method 100, and the method 100 is not limited to such operations and functionality. Instead, embodiments of the method 100 may utilize any data and calculation and quantitative processing techniques described herein.

The organization evaluated by the method 100 may be any organization known in the art. Moreover, the evaluated organization can encompass one or more environments. For example, the data at step 103 may be received from a plurality of remotely working employees and the organization encompasses these different remote environments.

Further, in an embodiment of the method 100, the health score created at step 106 is an actionable indication of the given organization's culture. As such, an embodiment of the method 100 may further include processing (e.g., quantitatively evaluating, thresholding, etc.) the health score for the given organization to determine an actionable event and providing 107 an indication of the determined actionable event to a user or outputting 107 a signal or other such command that automatically causes or implements the actionable event. Another embodiment of the method 100 compares the health score created at step 106 to a threshold and sends 107 an alert to a user based on results of the comparing. Embodiments of the method 100 may also cause an action to occur automatically based upon a health score created at step 106. For example, an embodiment, in conjunction with other systems, may cause the automatic creation (via the outputting 107) of 1:1 (one-on-one) meetings with employees and their managers for groups with low management-access or adding extra vacation days for groups that have a low work-life score. The meetings and extra vacation days, for non-limiting example, may be automatically scheduled through an electronic calendaring application or other communications platform. Yet another embodiment of the method 100, in response to determining a health score, automatically modifies a computing system to provide additional tools and allocate more resources to, for example, facilitate communication and improve work efficiency for an organization (or particular members thereof) with a low health score.

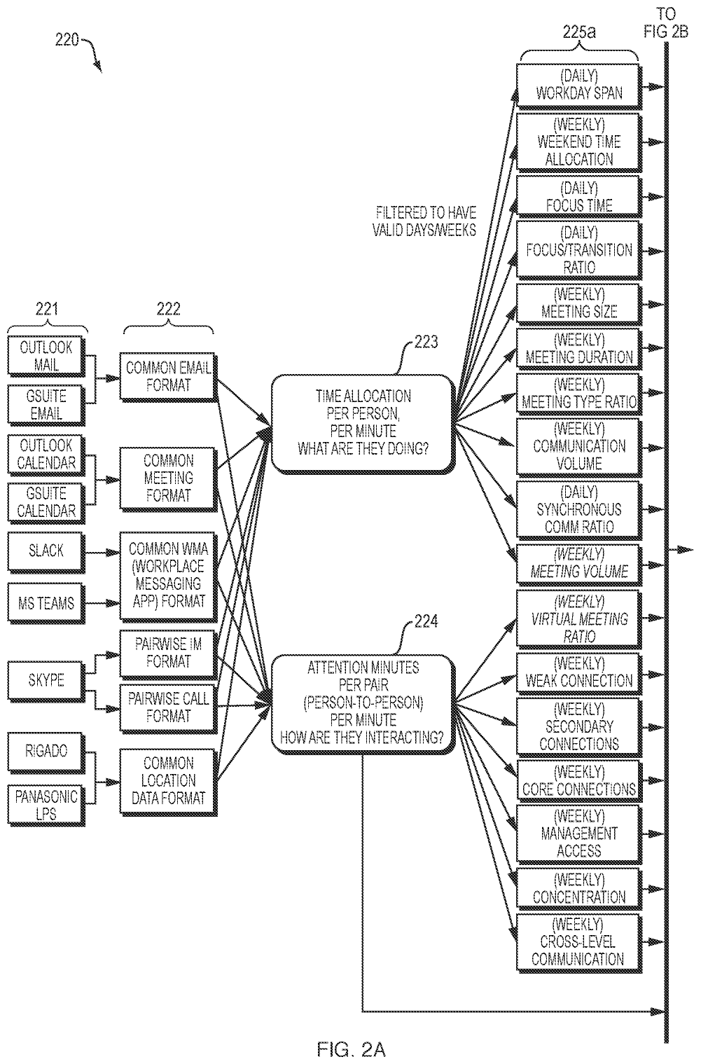

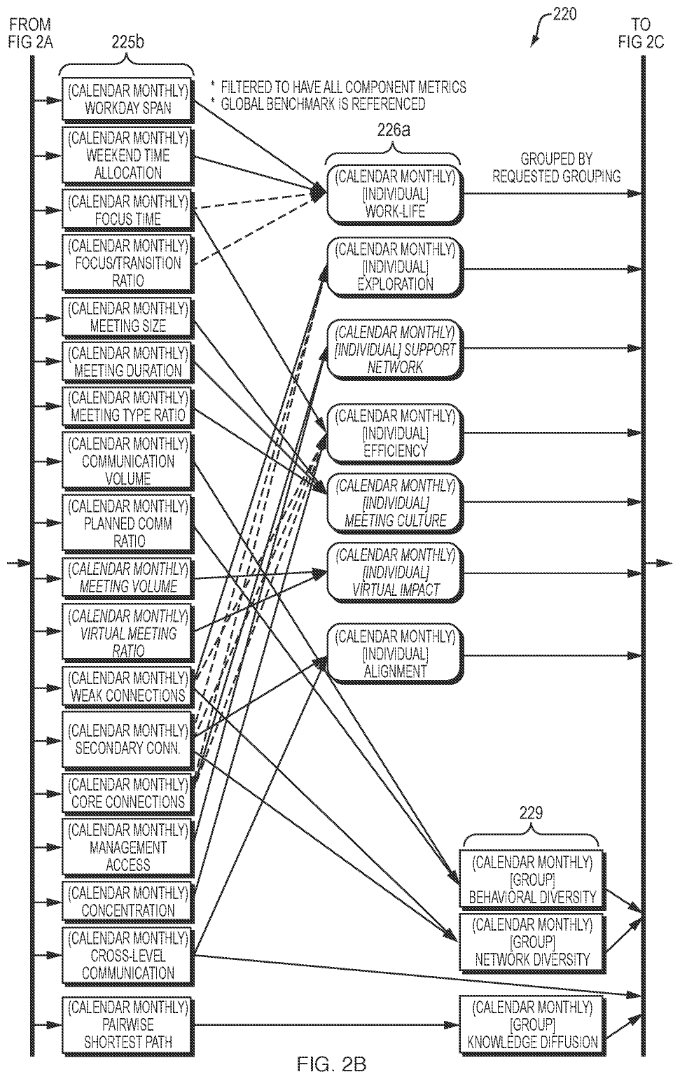

FIG. 2 is a flowchart depicting the dataflow of a method 220 for evaluating an organization according to an embodiment. The method 220 begins with the electrical communication data 221 and processes the electrical communication data 221 into common format or pairwise format data 222. For non-limiting example, the electrical communication data 221 includes various email, various electronic calendar data, group audio-visual communications data, and associated platforms recorded data, device to cloud connectivity and computation data, device networks data, and enterprise Internet of Things data (e.g., location data and the like). The common or pairwise formats 222 may include, for non-limiting example, a common email format, common meeting data format, common workplace messaging app (WMA) data format, pairwise Instant Messaging (IM), pairwise call data format, and a common location data format.

In turn, the common format data 222 and pairwise format data 222 is processed (quantitatively analyzed) to create the time allocation data 223 and attention minutes data 224. The time allocation data 223 and attention minutes data 224 indicates how each person (employee) from whom the data 221 was collected, spends their time (time allocation data 223) and how they interact with others (attention minutes data 224). In an embodiment, the time allocation data 223 indicates what individuals (employees) are doing at a per person, per minute, level of granularity, and the attention minutes data 224 indicates how individuals (employees) are interacting at a per pair (person-to-person), per minute, level of granularity. In an embodiment of the method 220, the time allocation data 223 and attention minutes data 224 are determined as described in U.S. Patent Publication No. 2020/0042928 A1 herein incorporated by reference in its entirety.

To continue, the time allocation data 223 and attention minutes data 224 are processed to determine a value for each objective measure 225a on an individual employee basis. In other words, a quantitative value for each objective measure 225a is determined for each individual employee. An embodiment of the method 220 filters the time allocation data 223 and attention minutes data 224, used to determine values for the objective measures 225a, to only include data for valid days and valid weeks. The validity criteria may be based upon user input and settings.

For non-limiting example, shown in FIG. 2 for a given employee, the values for the objective measures 225a of Workday Span, Weekend Time Allocation, Focus Time, Focus/Transition ratio, Meeting Size, Meeting Duration, Meeting Type Ratio, Communication Volume, Synchronous Communications ratio, and Meeting Volume are determined as a function of the time allocation data 223 of the employee. The values for the weekly objective measures 225a of Virtual Meeting Ratio, Weak Connections, Secondary Connections, Core Connections, Management Access, Concentration, and Cross-level Communication are determined as a function of the attention minutes data 224 of the employee. The Weak Connections are the count of people an individual interacts with between 5-15 attention-minutes in a week. Secondary Connections are counts of people an individual interacts with between 15-50 attention-minutes in a week. Core Connections are counts of people an individual interacts with more than 50 attention-minutes in a week. Other similar daily and weekly objective measures or metrics 225a are suitable.

From the metrics 225a, a representative value is chosen per calendar month for corresponding monthly metrics 225b. In an embodiment, a calendar month is defined as Monday-to-Sunday, weeks of which the Wednesday falls in that calendar month. According to an example embodiment, from the valid data points within a calendar month the median of values is chosen as the calendar-month's representative value. In other words, in such an embodiment, the median values for daily or weekly objective measures 225a are calculated as the values for the monthly metrics 225b. The median value for daily Workday Span objective measures 225a of an employee is the value for the monthly Workday Span objective measure 225b. The median value for daily Weekend Time Allocation objective measures 225a of the employee is the value for the monthly Weekend Time Allocation objective measure 225b. The median value for daily Focus Time objective measures 225a of the employee is the value for the monthly Focus Time objective measure 225b. The median value for daily Focus/Transition ratio objective measures 225a of the employee is the value for the monthly Focus/Transition ratio objective measure 225b. The median value for weekly Meeting Size objective measures 225a of the employee is the value for the monthly Meeting Size objective measure 225b. The median value for weekly Meeting Duration objective measures 225a of the employee is the value for the monthly Meeting Duration objective measure 225b. The median value for weekly Meeting Type Ratio objective measures 225a of the employee is the value for the monthly Meeting Type Ratio objective measure 225b. The median value for weekly communication volume objective measures 225a of the employee is the value for the monthly communication volume objective measure 225b. The median value for daily Synchronous Communication ratio objective measures 225a of the employee is the value for the monthly Planned Communication ratio objective measure 225b. The median value for weekly meeting volume objective measures 225a of the employee is the value for the monthly meeting volume objective measure 225b. The median value for weekly virtual meeting ratio objective measures 225a of the employee is the value for the monthly virtual meeting ratio objective measure 225b. The median value for the weekly Weak Connections objective measures 225a of the employee is the value for the monthly Weak Connections objective measure 225b. The median value for the weekly Secondary Connections objective measures 225a of the employee is the value for the monthly Secondary Connections objective measures 225b. The median value for the weekly Core Connections objective measures 225a of the employee is the value for the monthly Core Connections objective measure 225b. The median value for weekly Management Access objective measures 225a of the employee is the value for the monthly Management Access objective measure 225b. The median value for the weekly Concentration objective measures 225a of the employee is the value for the monthly Concentration objective measure 225b. The median value for the weekly Cross-level Communication objective measures 225a of the employee is the value for the monthly Cross-level Communication objective measure 225b.

For each employee, a monthly metric (objective measures) 225b for the pairwise shortest path is calculated as a function of attention minutes data 224 of the employee. In an embodiment, the monthly pairwise shortest path objective measure 225b represents the average number of hops one needs to go through to get to others in the group, when filtering all two-person connections to being only 5 attention-minutes or longer per week. For instance, if employee A and employee B interact more than 5 attention-minutes in a week, the shortest-path between them is 1. If employee A and employee B interact less than 5 attention-minutes a week, but they both interact more than 5 attention minutes per week with employee C, then the shortest path between A and B is 2.

In an embodiment, portions of the time allocation data 223 and attention minutes data 224 are excluded, i.e., filtered, from determining the values for the objective measures 225a and 225b using the techniques described herein below under the heading “Data Validation (Inclusion Criteria).” In such an embodiment, scores (values) for the objectives measures 225a and 225b are only determined using valid data and, as such, scores are only determined for individual employees with valid data, i.e., data that meets inclusion criteria. Further, in an embodiment of the method 220, the scores for the objective measures 225a and 225b may be determined utilizing the functionality described hereinbelow under the heading “Evaluating Metric Amongst Global Distribution (Percentiles).”

To continue, for each employee, the scores for the monthly objective measures 225b of the individual employee are aggregated to determine a score for each behavioral indicator 226a of the employee. An embodiment filters the behavioral indicator 225b data to only include data where all needed behavioral indicator, i.e., component metric, 225b data exists. In other words, in such an embodiment, when determining scores for behavioral indicators 226a, scores for the behavioral indicators 226a are only determined where all objective measure 225b scores necessary exist. To illustrate, consider the example of the virtual impact behavioral indicator 226a. The virtual impact behavioral indicator 226a score is based on the meeting volume and virtual meeting ratio component metric 225b scores. In this illustrated example, for a given employee, a score for the virtual impact behavioral indicator 226a is only determined when, for the given employee, scores for both the meeting volume and virtual meeting ratio objective measures 225b have been determined. Otherwise, a score for the virtual impact behavioral indicator 226 is not established for the employee.

In an embodiment, evaluating a metric, i.e., objective measure 225b, to determine a behavioral indicator score 226a is about getting the percentile (rank) of a new observation (a metric value for an employee or group based on time allocation data or attention minutes data) in the previously benchmarked population. This may include comparing objective measure 225b values to global benchmarks to determine the percentile values for the behavioral indicators 226a. To illustrate, once again consider the example of determining a score for the virtual impact behavioral indicator 226a based on the meeting volume and virtual meeting ratio component metric 225b values. In this example, a given employee's scores for the meeting volume and virtual meeting ratio objective measures 225b are compared to global benchmarks for meeting volume and virtual meeting ratio, to determine the employee's rank for meeting volume and virtual meeting ratio amongst the global population. In turn, these determined ranks are combined to determine the score for the virtual impact behavioral indicator 226a.

In an embodiment of the method 220, different monthly objective measure 225b scores of the employee are aggregated for different behavioral indicators 226a of the employee. For non-limiting example, the monthly objective measure scores 225b for Workday Span, Weekend Time Allocation, Focus Time, and Focus/Transition ratio of an employee are aggregated to compute the Work-life behavioral indicator score 226a for the employee. The employee's monthly objective measure scores 225b for Weak Connections, Secondary Connections, and Core Connections are aggregated to compute the Exploration behavioral indicator score 226a of the employee. The employee's monthly objective measure scores 225b for Core Connections and Management Access across several months are aggregated to compute the Support Network behavioral indicator score 226a of the employee. And so forth for other behavioral indicators 226a (i.e., Efficiency, Meeting Culture, Virtual Impact, and Alignment) of the employee, and iterated across the behavioral indicators 226a for each employee, as illustrated in FIG. 2. That is, the Efficiency indicator score 226a is a function of or based on the monthly objective measure scores 225b of Weak Connections, Secondary Connections, Core Connections, and Concentration for a subject employee. The Alignment behavioral indicator score 226a is a function of or based on the employee's monthly objective measure scores 225b for Secondary Connections and Cross-Level Communication. The Meeting Culture behavioral indicator score 226a is a function of or based on the monthly objective measure scores 225b of Meeting Size, Meeting Duration, and Meeting Type Ratio of the employee. The Virtual Impact behavioral indicator score 226a is a function of or based on the monthly objective measure scores 225b of Virtual Meeting Ratio and Meeting Volume.

In an embodiment of the method 220, a distribution of the individual employee scores for the behavioral indicators 226a across different employees is used to determine group scores referred to as group behavioral indicators 226b. Restated, for a group of employees, the scores of the behavioral indicators 226a of each employee in the group are evaluated to produce the group behavioral indicator 226b score for the group. This may be done by grouping scores for the behavioral indicators 226a according to requested groupings to determine the group behavioral indicator scores 226b. For non-limiting example, the Work-life behavioral indicator 226a scores of each employee member of the group are evaluated to produce the Work-life group behavioral indicator 226b score for the group. The Exploration behavioral indicator 226a scores of each employee member of the group are evaluated to produce the Exploration group behavioral indicator 226b score for the group. The Support Network behavioral indicator scores 226a of each employee member of the group are evaluated to produce the Support Network group behavioral indicator 226b score for the group. The Efficiency behavioral indicator scores 226a of each employee member of the group are evaluated to produce the Efficiency group behavioral indicator 226b score for the group. The Alignment behavioral indicator scores 226a of each employee member of the group are evaluated to produce the Alignment group behavioral indicator 226b score for the group. The Meeting Culture behavioral indicator scores 226a of each employee member of the group are evaluated to produce the Meeting Culture group behavioral indicator 226b score for the group. The Virtual Impact behavioral indicator scores 226a of each employee member of the group are evaluated to produce the Virtual Impact group behavioral indicator 226b score for the group. And so forth as illustrated in FIG. 2.

In an embodiment, each individual behavioral indicator 226a score is bucketed into three categories—critical (bottom 10 percentile), warning (between 10-40 percentile) and good (the top 60 percentile). For each group, the proportion of employee scores in these three buckets is examined to determine if there is a disproportionate number in any bucket category. If a group has a disproportionately high number of employees in the “critical” bucket (more than the expected 10%), then the group's indicator score 226b will tend to be lower. On the other hand, if a group has a disproportionately high number of the individual employees on the “good” bucket, the group's indicator score 226b will tend to be higher.

In embodiments, different groups may have different sets of employees, and thus different scores for each of the group behavioral indicators 226b. For the number of groups, there are potentially that number of scores for each of the group behavioral indicators 226b Work-life, Exploration, Support Network, Efficiency, Meeting Culture, Virtual Impact, Alignment, Flexibility, and Organization Flatness illustrated in FIG. 2.

In one embodiment, across multiple (perhaps all) employees, the monthly objective measure scores 225b for Planned Communications ratio and Communication volume are evaluated to form a Behavioral Diversity group parameter value 229. Similarly, across multiple employees, the monthly objective measure scores 225b for Weak Connections and Secondary Connections are summed to form a Network Diversity group parameter value 229. The Behavioral Diversity parameter value 229 and the Network Diversity parameter value 229 are evaluated (as further discussed below) to produce the Flexibility group behavioral indicator score 226b. Across multiple (perhaps all) employees, the monthly objective measure values 225b for Pairwise Shortest Path define a Knowledge Diffusion group parameter value 229. The employees' monthly objective measure scores (values) 225b for Cross Level Communication are evaluated with the Knowledge Diffusion parameter value 229 to produce an Organization Flatness group behavioral indicator 226b score.

According to an embodiment of the method 220, the scores (values) for the behavioral indicators 226a and 226b and group parameters 229 are determined using the techniques and operations described hereinbelow under the headings “Evaluating Behavioral Indicators,” and “Calculating Group Scores From Individuals' Scores.”

The scores for the group behavioral indicators 226b are aggregated to determine values for the organization characteristics 227. For non-limiting example, the group behavioral indicator 226b scores for Work-life, Exploration, and Support Network are aggregated to compute the value for the Engagement organization characteristic 227. The group behavioral indicator 226b scores for Efficiency, Alignment, Meeting Culture, and Virtual Impact are aggregated to compute the value for the Productivity organization characteristic 227. The group behavioral indicator 226b scores for Flexibility and Organization Flatness are aggregated to compute the value for the Adaptability organization characteristic 227.

The scores for the organization characteristics 227 (Engagement, Productivity, and Adaptability) are, in turn, aggregated to determine the organization health score (OHS) 228. In an embodiment of the method 220, the scores for the organization characteristics 227 and the score for the organization health (OHS) 228 are determined using the methodologies described hereinbelow under the heading “Aggregate Multiple Components To Determine Higher-Level Score.”

As described herein, embodiments, e.g., the methods 100 and 220, utilize time allocation data (e.g., the data 223) and attention minutes data (e.g., the data 224). According to an embodiment, the time allocation data and attention minutes data is determined from electronic communication data 221 of individuals (employees). Such data may be derived from any electronic communication data known in the art. Further, the time allocation data 223 and attention minutes data 224 utilized in embodiments, such as the data from a plurality of organizations used to determine benchmarks and the data from an individual organization used to evaluate the individual organization, can be organized in data storage, e.g., one or more databases, utilizing any methodologies known in the art. Moreover, the data used throughout embodiments, such as the values for objective measures 225a, 225b, working parameters 229, behavioral indicator scores 226a, 226b, organization characteristic scores 227, and organization health scores 228, amongst other examples, may also be organized in data storage that is accessible to a computing device implementing embodiments.

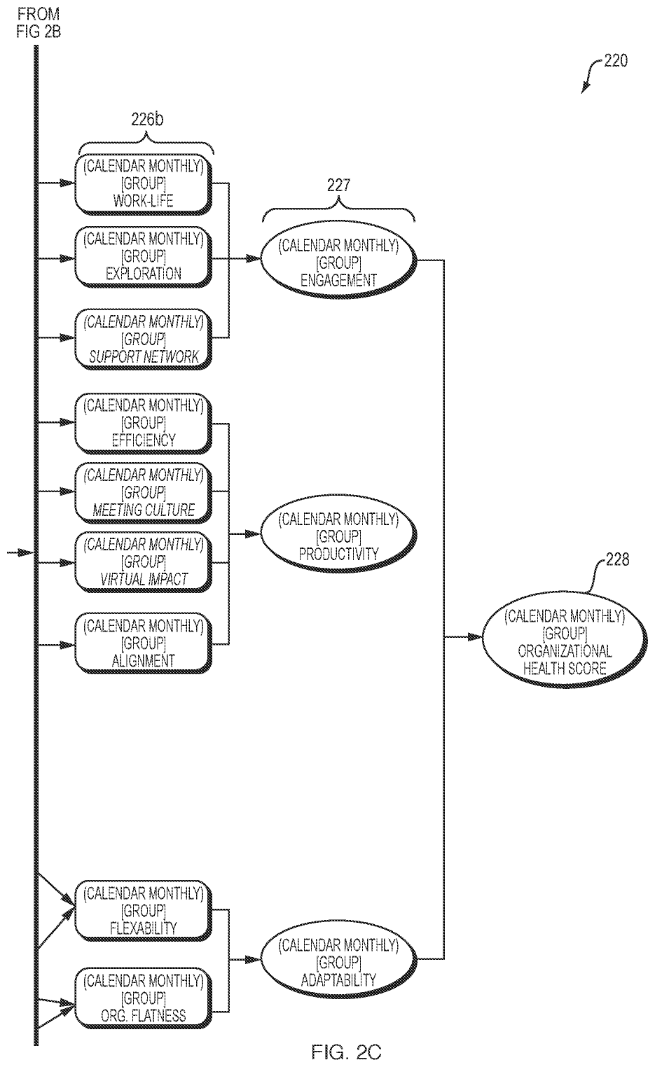

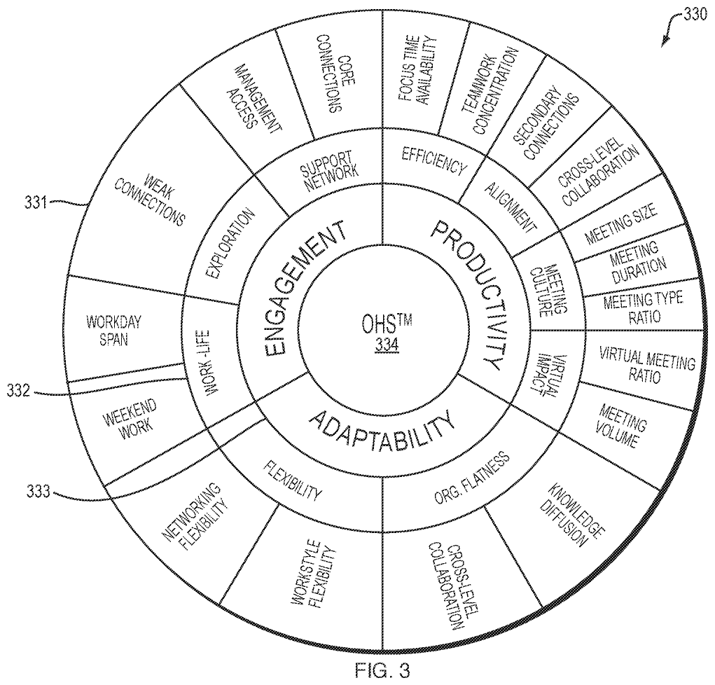

FIG. 3 is a wheel diagram 330 illustrating indicators and metrics that may be utilized to determine an organization health score 334 according to an embodiment. The outermost layer 331 includes objective measures (like 225a, 225b detailed in FIG. 2) that are based on time allocation data 223 and attention minutes data 224 of users. The next layer 332 is composed of behavioral indicators (like 226a, 226b detailed above) that are determined by aggregating one or more objective measures from the outer layer 331. The layer 333 includes the organization characteristics (like 227 detailed above) which are aggregated to determine the organizational health score 334.

In embodiments, data for objective measures 225a, b, i.e., metrics of organization behavior, behavioral indicators 226a, b, organization characteristics 227, and organization health scores 228 may be stored in computer memory organized in hierarchical categories that include one or more sub-categories. Example categories and sub-categories of data are given in Table 2 below.

TABLE 2
Metrics of Organizational Behavior

| category | sub_category |
|---|---|
| degree | core_exclusive |
| degree | significant_exclusive |
| degree | loose_exclusive |
| concentration | top5_ratio |
| time_allocation_communication_medium | weekend_ta |
| time_allocation_communication_medium | overall_chat |
| time_allocation_communication_medium | overall_callnomeeting |
| time_allocation_communication_medium | overall_email |
| time_allocation_communication_medium | overall_meeting |
| time_allocation_communication_medium | overall_nocommunication |
| time_allocation_communication_medium | synchronous_comm_ratio_m2me |
| time_allocation_activity | comm_time_per_hr |
| time_allocation_activity | focus_time_per_hr |
| time_allocation_activity | transition_time_per_hr |
| time_allocation_activity | focus_to_nocomm_ratio |
| workday_span | overall |
| response_time | overall_alldays |
| response_time | overall_weekdays |
| response_time | overall_weekends |
| response_time | work_weekdays |
| response_time | afterwork_weekdays |
| cross_level_communication | manager_nonmanager_ratio |
| knowledge_diffusion | intragroup |
| exploration | |
| overwork | |
| efficiency | |
| alignment | |
| organizational_flatness | |
| flexibility | |
| engagement | |
| productivity | |
| adaptability | |
| OHS | |

### Data Validation (Inclusion Criteria)

An embodiment implements data validation, i.e., determines what data is valid to use. In an embodiment, the validation determines what metric data points are valid for a given time period, e.g., a day, a week, etc., and may also utilize who the data pertains to as an inclusion/exclusion criterion. In an embodiment, the following criteria are used to determine whether a time period is valid and whether an individual employee (his data) is valid for consideration in the benchmark/indicator determination.

### 1. Valid Time Period Per Company

The valid time period per company criteria includes/excludes data about a company as a whole. This criterion accounts for issues with missing data for a large percentage of the population, i.e., a company's employees. In an example embodiment, per company, a week is considered valid for analysis if there are a minimum of 4 valid days of data in the week. According to an embodiment, a day is valid if a minimum amount of communication activity is detected at the company level for the day. According to an embodiment, this minimum amount is calculated by summing the total digital time allocation for all participants during the day, and comparing the total digital time allocation to a minimum threshold. In an embodiment, the minimum threshold is the number of participants times 30 minutes per participant. If the total company communication activity detected or measured exceeds the threshold, then the day is considered valid. In an embodiment, the threshold is ⅙ of the expected communication activity per person based on benchmark values (individuals typically spend ˜3 hours per day on digital communication). In one such embodiment, speed and accuracy are improved by only using valid weeks to calculate benchmarks, and limiting queries (evaluations of a given company's health) to weeks where valid data exists for the company.

### 2. Valid Time Period Per Individual Employee

The valid time period per individual employee criteria includes/excludes data on a per person basis. This criterion accounts for missing data at the individual employee level due to limited digital activity, holidays, and vacations, amongst other examples, of the individual. First, it is noted that in an embodiment, individual employee data is only considered for inclusion if the individual employee data is from a valid time period according to the first criteria (Valid Time Period Per Company). Assuming the data is from a valid time period at the company level, a given individual's data is included if the individual has a minimum of 3 days of digital activity for the given medium or combination of mediums specified, e.g., email and call data. An embodiment defaults to considering all mediums, i.e., methods of communications/sources of digital communication data. According to an embodiment, for data from a day to be valid, the week that includes the day must also be considered valid, i.e., the week must be valid for the days within the week to be considered valid. As such, these criteria apply to both daily and weekly metrics, e.g., objective measures and behavioral indicators. For daily metrics, if the participant has missing days in a valid week, the missing days are attributed with a value of ‘0’.

### 3. Valid Data Point for Benchmark/Indicator

For data pertaining to a weekly metric to be considered valid for determining benchmark values and/or evaluating a particular organization, that data must come from individuals (employees) who have a minimum of 4 valid weeks of data. For data pertaining to a daily metric to be considered valid for determining benchmark values and/or evaluating a particular organization, that data must come from individuals (employees) who have a minimum of 15 valid days of data. To be considered when determining benchmarks, a company must have a minimum of 20 valid participants each with a sufficient number of data points. Moreover, the company size should be greater than 50 employees, according to an embodiment.

It is noted that the aforementioned data validation criteria are merely examples and embodiments are not so limited. As such, embodiments may utilize any desired criteria and set any user desired values for criteria for data exclusion/inclusion. In an embodiment, the inclusion criteria are applied to data that is aggregated to determine benchmarks for particular objective measures and, likewise, the inclusion criteria are also applied to include/exclude data when evaluating a given organization.

### Evaluating Metric Amongst Global Distribution (Percentiles)

Evaluating a metric, i.e., objective measure 225a, 225b, is about getting the percentile (rank) of a new observation (a metric value for an employee or group based on time allocation data or attention minutes data) in the previously benchmarked population. In other words, evaluation of a metric begins with a value for a metric, e.g., workday span, for an individual employee (which is based upon time allocation and/or attention minutes data) and determines the percentile of this metric compared to the metric value of other employees. Such functionality may include comparing a score for an objective measure to an expected distribution for the objective measure to determine a percentile.

Accordingly, the inputs of this step are: (1) new observation metric value (to find its place in the global distribution) and (2) previously calculated distribution (percentiles) of the metric (which are calculated based on a previous population). The output of the evaluation is the percentile (a value between 0 and 100) of the new observation that represents the “global” rank of the employee for this metric.

### Inputs

In this subsection, the two inputs are defined and the steps to prepare these inputs are provided. The first input is a particular metric value for a particular individual (employee). This may be a single numeric metric value that is calculated for an individual over a period of time. The value may be calculated based on time allocation data 223 and/or attention minutes data 224 that is gathered from electronic communication data 221. The second input is distribution/percentiles (benchmark results) for a particular metric. This may include, for a particular metric, metric values calculated for many employees. In such an example, each employee is represented with a single value (aggregated over a time period). The benchmark values may be processed using the aforementioned inclusion criteria to decide whose data to include in the benchmarking for what period of time.

### First Input (Particular Metric Value for Particular Individual Employee) Preparation

What follows is an example of preparing the individual employee metric value. Given an employee E, metric M, and date-range (start-date, end-date) DR, an embodiment first calculates the average/median metric (M) score of E over the date range DR. The list of metrics is provided in Table 2. This function can be conceptualized as: (1) metric M has a “temporal resolution,” i.e., it is often defined at daily or weekly level and, at this step, the metric M score is calculated for all valid days or weeks of employee E in the given date range and (2) aggregate the metric M scores (i.e., often, mean or median) of E over the date-range DR to get a single numeric value. For instance, this may include aggregating data for the daily or weekly objective measures 225a to determine score for monthly objective measures 225b. The below is an example of pseudocode that performs this functionality:

```
function calculate_metric_score(E,M,DR):
  resolution = get_resolution(M) # it is often a day or a week
  time_periods = slice DR by resolution
  results = [ ]
  for each time_period in time_periods:
    if is_valid(E,M,time_period):
      results.append(calculate(E,M,time_period))
  return aggregate(results) # a numeric value
```

### Second Input (Benchmark Results) Preparation

The previous subsubsection (“First Input Preparation”) introduced the function of calculate_metric_score. In an embodiment, the calculate_metric_score function is called for each employee of all employees, in all companies, over all date ranges possible. In other words, metric values are calculated using all available and valid data using the above mentioned process. As such, for each employee E (regardless of the employee's company and the length of time period) a single numeric metric value (score) of V is calculated. Over the distribution of all V values, an embodiment determines the n-tiles (often percentiles). Thus, for each metric, such an embodiment determines a series of non-decreasing numbers representing the n-tile values (percentiles). In embodiments, such a series for metric M is referred to as the benchmark (or benchmark table/values) of M. The below is an example of pseudocode that performs this functionality:

```
function calculate_benchmark_scores(M,n=100):
  scores = [ ]
  for each company C in companies:
    for each employee E in C:
      DR = get_maximum_date_range(E)
      scores.append(calculate_metric_score(E,M,DR))
  return get_ntiles(scores,n) # a non-decreasing series of length n
```

### Process and Output

The previous subsections (Inputs, First Input Preparation, and Second Input Preparation) described what the inputs are and how to prepare the inputs. The processing and outputting is about locating the place of input-1 in input-2. Again, input-1 represents the value of a certain metric M for a certain employee E over a certain date period DR, and input-2 represents the global distribution (n-tiles or n bins) of a metric. Here, an embodiment finds the bin, e.g., bin number, into which the new observation falls. The output is an integer representing the tile. The below is an example of pseudocode that performs this functionality:

```
function get_ntile(E,M,DR,n=100):
  V = calculate_metric_score(E,M,DR) # a numeric value
  T = calculate_benchmark_scores(M,n=n) # a non-decreasing series
  return get_ntile(V,T) # an integer in [1,100]
```

### Evaluating Behavioral Indicators

Once percentiles for objective measures 225a, b are determined, embodiments use one or more metric/percentile determinations to calculate individual employee behavioral indicator values 226a. This functionality may combine one or more metrics/percentiles to get values for the individual employee behavioral indicators 226a. An embodiment first assigns a metric score and then aggregates metric scores to determine a combined base indicator score.

### Assigning a Metric Score

Once an individual's (employee's) global ranking is determined for each metric, a ‘metric score’ is assigned accordingly. An embodiment assigns a unitless metric score that ranges from 0-1, and either rewards or penalizes each individual employee based on their position in the global distribution. A score closer to 0 indicates less desirable behaviors, whereas a score closer to 1 indicates ideal behavioral traits (e.g., individuals who have the longest workdays [top 10%] would be penalized significantly, and have metric scores closer to 0 compared to individuals with healthier working hours).

The advantages of using an unitless metric score are two-fold. First, by converting raw metric values (e.g., workday span quantified in hours and degree quantified by number of contacts) to unitless scores, various dimensions of individual employee communication and workstyle behaviors can be combined to model an indicator. Second, this conversion to unitless metric scores also allows for more robust modeling, since the unitless scores are not based on just the raw metric values (which may be approximated values for some metrics), but are instead based on relative global rankings of individuals (employees). This allows for more flexibility in the measurement method of the metric because the relative value is of interest, not the absolute value.

In an embodiment, the conversion to a unitless metric score is unique to the metric/indicator combination. One such embodiment, utilizes context from organizational behavioral science to drive the conversion methodology per indicator and, as such, the same metric may have different conversion logics if used in two different indicators.

### Aggregating Metric Scores to a Combined Base Indicator Score

After calculating the component metric scores, an embodiment employs an indicator-specific function to combine the metric scores to an overall indicator score by assigning varying weights to each of the components based on their relative predictive power in quantifying the organizational health behavior represented by the base indicator. In embodiments, some component metric scores have modulating effects to account for desired trade-offs between competing metrics. An embodiment determines final individual employee base indicator scores that range from 0-10, and the global distribution of benchmarked values can vary in form.

### Calculating Group Scores from Individuals' Scores

Once individual employee behavioral indicator scores 226a are determined, an embodiment aggregates individual employee behavioral indicators scores to determine behavioral indicator scores 226b for a group of people. In doing so, an embodiment calculates the deviation of the behavioral indicator scores for a group of individuals from the expected distribution of behavioral indicators for a group of people.

For a given group of individuals (employees), an embodiment categorizes individuals' scores as either “good,” “warning,” or “critical,” such that scores above the benchmark 40th percentile are categorized as “good,” those between the 10th and 40th percentiles are categorized as “warning,” and scores below the 10th percentile are categorized as “critical.”

Seeing as the benchmark percentiles, e.g., ventiles, are calculated using the global population data, one would expect that on average, 60% of the individuals in a group will have “good” scores, 30% will have “warning” scores, and 10% will have “critical” scores. If the individuals (employees) for the particular group do indeed have scores that precisely match this expected distribution, then a group score of 7.0 is assigned. If, however, the group has more individuals with “good” scores than the expected 60%, the group is assigned a score greater than 7.0 (explained more fully below). Likewise, if the number of “critical” and “warning” scores is greater than their expected ratios, this will negatively impact the group score, thereby allowing for group scores less than 7.0. It is noted that a deviation of 1% in weighted order of “critical”>“warnings”>“good” scores is used. For instance, if one has 1% more of “critical” individuals (employees) that negatively affects the score by 2 times more than if one had 1% more of “warnings” individuals (employees), and 4 times more than if one had 1% less of “good” individuals.

A formula that is employed in embodiments follows. The formula uses the following definitions: (1) Expected score ratio (ExpectedRatio) for Critical, Warning, Good is [10, 30, 60] by default, (2) Actual score ratio (ActualRatio) is the ratio of individuals' (employees of a group) scores that is observed in the population, and (3) Score penalties (Penalties) for Critical, Warning, Good is [−4, 31 2, 1] by default. A raw score (Raws core) is first calculated using the following equation:

RawScore=(ActualGood %−ExpectedGood %)*(GoodPenalty)+(ActualWarning %−ExpectedWarning %)*(WarningPenalty)+(ActualCritical %−ExpectedCritical %)*(CriticalPenalty)

Using the above equation, and given the possible ExpectedRatio and Penalties values, it is noted that the maximum value of RawScore (maxRawScore) occurs when the ActualRatio==[0, 0, 100], (i.e., all Good scores). The minimum value of RawScore (minRawScore) occurs when the Actual Ratio==[100, 0, 0], (i.e., all Critical scores). Further, RawScore==0 only when ActualRatio==ExpectedRatio (i.e., when the actual ratio matches the expected ratio).

After the raw score is determined, an embodiment scales the RawScore value to a [0.0, 10.0] range (ScaledScore). On an observation of the RawScore==0, meaning the actual ratio matches the expected ratio, an embodiment sets ScaledScore to 7.0.

When RawScore>0, such an embodiment scales the value to a (7.0, 10] range (i.e., not inclusive of 7) due to the first observation, that the range of values of RawScore is (0, maxRawScore]. The value range is not inclusive of 0. An embodiment calculates relative percentile Of RawScore on this range, calculates percentile\hat{ }2 (to widen distribution), finds the equivalent percentile value on the (7.0, 10] range (i.e., not inclusive of 7), and sets ScaledScore to this value.

When RawScore<0, an embodiment scales the value to a [0.0, 7.0) range (i.e., not inclusive of 7). Due to the observation that the range of values of RawScore is [minRawscore, 0), i.e., not inclusive of 0, an embodiment calculates relative percentile of RawScore on this range, calculates (1−(1−percentile\hat{ }2)) (to widen distribution), finds the equivalent percentile value on the [0, 7.0) range (i.e., not inclusive of 7), and sets ScaledScore to this value.

Table 3 below shows example scores (for group behavioral indicators 226b) calculated using the aforementioned process with values for (ExpectedRatio==[10, 30, 60] and Penalties ==[−4, −2, 1]).

TABLE 3
Example Scores

| | Critical | Warning | Good | Group |
|---|---|---|---|---|
| | % | % | % | Score |
| Case 1 | 10 | 30 | 60 | 7.0 |
| (Default Expected) | | | | |
| Case 2 | 15 | 35 | 50 | 5.5 |
| Case 3 | 20 | 40 | 40 | 4.2 |
| Case 4 | 30 | 50 | 20 | 2.2 |
| Case 5 | 5 | 25 | 70 | 8.5 |
| Case 6 | 0 | 20 | 80 | 9.4 |
| Case 7 | 0 | 10 | 90 | 9.9 |
| Case 8 | 0 | 0 | 100 | 10.0 |
| Case 9 | 100 | 0 | 0 | 0.0 |
| Case 10 | 70 | 30 | 0 | 0.2 |
| Case 11 | 50 | 50 | 0 | 0.5 |
| Case 12 | 20 | 60 | 20 | 2.6 |
| (Exploration Expected) | | | | |

Table 4 below shows example scores (for group behavioral indicators 226b) calculated using the aforementioned process with values for (ExpectedRatio==[20, 60, 20] and Penalties==[−3, 1, 2]).

TABLE 4
Example Scores

| | Critical | Warning | Good | Group |
|---|---|---|---|---|
| | % | % | % | Score |
| Case 1 | 10 | 30 | 60 | 9.2 |
| (Default Expected) | | | | |
| Case 2 | 15 | 35 | 50 | 8.6 |
| Case 3 | 20 | 40 | 40 | 5.1 |
| Case 4 | 30 | 50 | 20 | 5.4 |
| Case 5 | 5 | 25 | 70 | 9.7 |
| Case 6 | 0 | 20 | 80 | 10.0 |
| Case 7 | 0 | 10 | 90 | 10.0 |
| Case 8 | 0 | 0 | 100 | 10.0 |
| Case 9 | 100 | 0 | 0 | 0.0 |
| Case 10 | 70 | 30 | 0 | 0.9 |
| Case 11 | 50 | 50 | 0 | 2.4 |
| Case 12 | 20 | 60 | 20 | 7.0 |
| (Exploration Expected) | | | | |

### Aggregate Multiple Components to Determine Higher-Level Score

Embodiments may utilize the group scores (scores for groups of employees) for behavioral indicators 226b or individual employee scores for behavioral indicators 226a to determine higher-level scores for an organization. This may include calculating focus area scores 227, 333 from particular behavioral level scores 226a, 226b, 332 that pertain to focus areas. These focus area scores (also referred to herein as organization characteristic scores) 227, 333 may also be combined to determine an overall organizational health score 228, 334. In an embodiment, both the focus area scores 227, 333 and overall organizational health score 228, 334 are calculated using the same equation:

Score=Average−(SD*0.2)

where Average is the average value of the components, i.e., the behavioral indicators 226a, 226b, 332 or focus indicators 227, 333 that are used to determine the score, and SD is the standard deviation of the components. When calculating the focus area scores 227, 333, the components are the behavioral indicator scores (of groups or individual employees) 226a, 226b, 332, and when calculating the overall organization health score 228, 334, the components are the focus area scores 227, 333.

To illustrate, consider an example of calculating an organizational health score (OHS) 228, 334 where the focus area scores 227, 333 are: engagement 9.1, productivity 8.0, and adaptability 5.9. In such an example, the average is 7.666 and the standard deviation is 1.625833. Thus, the computed overall OHS 228, 334 using the above formula is 7.3 (with rounding). The focus area score of 9.1 for Engagement 227, 333 is computed from (i) the average of behavioral indicator scores 226a, 226b, 332 for Work-life, Exploration, and Support Network minus (ii) two tenths of the standard deviation of the behavioral indicator scores 226a, 226b, 332 of Work-life, Exploration, and Support Network. The focus area score of 8.0 for Productivity 227, 333 is computed from (i) the average of behavioral indicator scores 226a, 226b, 332 for Efficiency, Alignment, Meeting Culture, and Virtual Impact, minus (ii) two tenths of the standard deviation of these behavioral indicator scores 226a, 226b, 332. The focus area score 5.9 for Adaptability 227, 333 is computed from (i) the average of behavioral indicator scores 226b, 332 for Flexibility and Organization Flatness, minus (ii) two tenths of the standard deviation of these behavioral indicator scores 226b, 332.

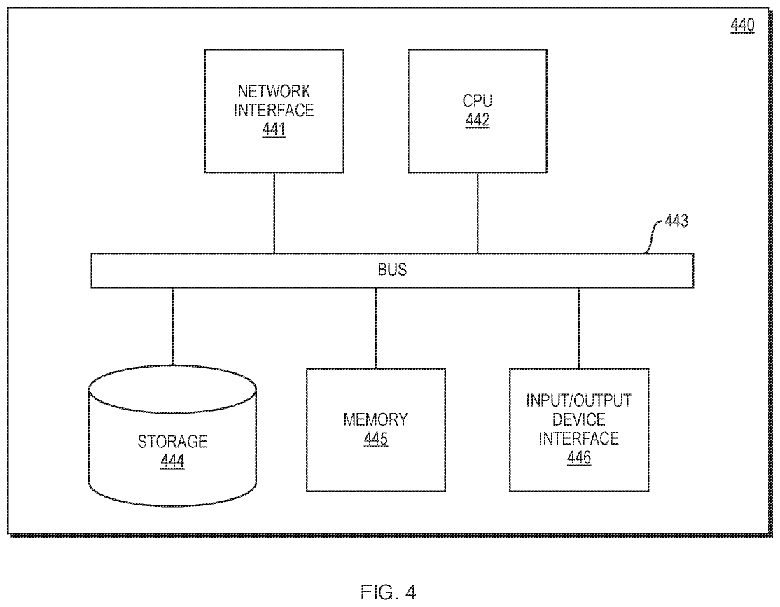

FIG. 4 is a simplified block diagram of a computer-based system 440 that may be used to monitor an organization according to any variety of the embodiments of the present invention described herein. The system 440 comprises a bus 443. The bus 443 serves as an interconnect between the various components of the system 440. Connected to the bus 443 is an input/output device interface 446 for connecting various input and output devices such as a keyboard, mouse, touch screen, display, speakers, etc. to the system 440. A central processing unit (CPU) 442 is connected to the bus 443 and provides for the execution of computer instructions. Memory 445 provides volatile storage for data (i.e., database of time allocation data 223 and attention minutes data 224, and/or electronic communication data 221, and corresponding common format data 222) used for carrying out computer instructions. Storage 444 provides non-volatile storage for software instructions, such as an operating system (not shown). The system 440 also comprises a network interface 441 for connecting to any variety of networks known in the art, including wide area networks (WANs) and local area networks (LANs).

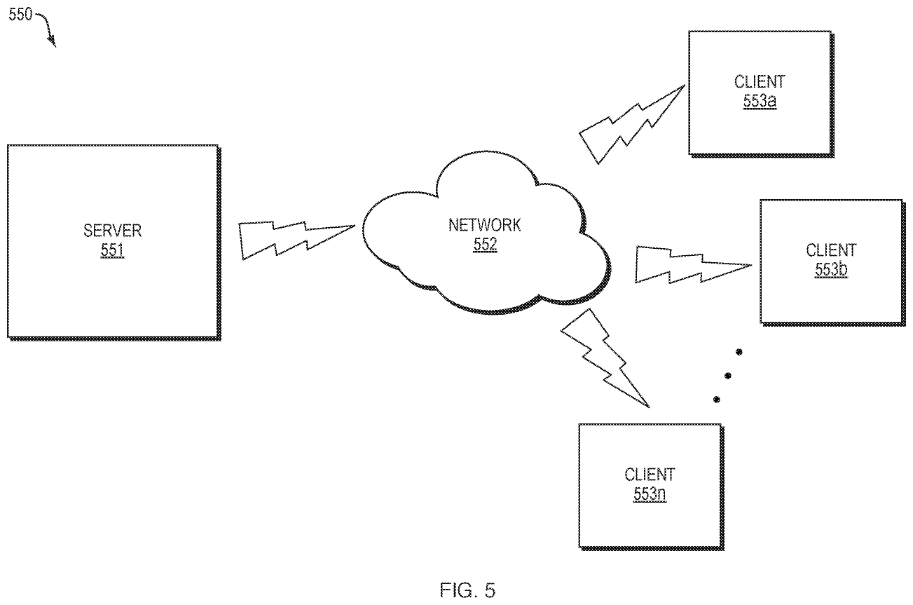

It should be understood that the example embodiments described herein may be implemented in many different ways. In some instances, the various methods and machines described herein may each be implemented by a physical, virtual, or hybrid general purpose computer, such as the computer system 440, or a computer network environment such as the computer environment 550, described herein below in relation to FIG. 5. The computer system 440 may be transformed into the machines that execute the methods described herein, for example, by loading software instructions 100, 220, 330 into either memory 445 or non-volatile storage 444 for execution by the CPU 442. One of ordinary skill in the art should further understand that the system 440 and its various components may be configured to carry out any embodiments or combination of embodiments of the present invention described herein. Further, the system 440 may implement the various embodiments described herein utilizing any combination of hardware, software, and firmware modules operatively coupled, internally, or externally, to the system 440.

FIG. 5 illustrates a computer network environment 550 in which an embodiment of the present invention may be implemented. In the computer network environment 550, the server 551 is linked through the communications network 552 to the clients 553a-n. The environment 550 may be used to allow the clients 553a-n, alone or in combination with the server 551, to execute any of the embodiments described herein. For non-limiting example, computer network environment 550 provides cloud computing embodiments, software as a service (SAAS) embodiments, and the like.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. An organization monitoring method, the method comprising:
aggregating, in a database, time allocation data and attention minutes data for a plurality of people at a plurality of organizations;
processing the aggregated time allocation data and attention minutes data from the database to determine a respective benchmark value for each of a plurality of objective measures;
receiving time allocation data and attention minutes data for members of a given organization;
for each member in a subset of the members of the given organization, scoring behavioral indicators for the member by:
processing the received time allocation data and attention minutes data to determine a value for each of the plurality of objective measures for the member;
assigning a metric score for the member for each of the plurality of objective measures by comparing the determined value for each of the plurality of objective measures to the determined respective benchmark value for each of the plurality of objective measures; and
aggregating one or more assigned metric scores to determine a respective score for each of a plurality of behavioral indicators for the member;
aggregating one or more of the respective scores for the plurality of behavioral indicators for the members in the subset to determine a respective score for each of a plurality of organization characteristics for the given organization; and
processing the respective scores for each of the plurality of organization characteristics to create a health score for the given organization.

2. The method of claim 1 wherein processing the aggregated time allocation data and attention minutes data further comprises:
excluding a subset of the aggregated data in determining the respective benchmark value for each of the plurality of objective measures.

3. The method of claim 2 wherein the subset of the aggregated data is excluded based upon at least one of:
a length of time over which data in the subset was collected; and
characteristics of a person associated with data in the subset.

4. The method of claim 1 further comprising:
determining each member in the subset of the members of the given organization based upon at least one of:
a length of time for which data associated with a member exists; and
characteristics of a member.

5. The method of claim 1 wherein aggregating the one or more assigned metric scores to determine a respective score for each of a plurality of behavioral indicators comprises:
for a given behavioral indicator, quantitatively processing the one or more assigned metric scores using a function specific to the given behavioral indicator to determine the respective score.

6. The method of claim 1 wherein the determined value for a given objective measure is a unitless metric value.

7. The method of claim 1 wherein the given organization encompasses one or more work environments.

8. The method of claim 1 wherein the health score is an actionable indication of the given organization's culture.

9. The method of claim 1 further comprising:
assessing the created health score for the given organization to determine an actionable event; and
providing an indication of the determined actionable event to a user.

10. The method of claim 1 wherein the objective measures include at least one of: typical workday, typical weekend, focus time, focus time availability, meeting size, meeting duration, distance to meeting rooms, behavioral diversity, network diversity, Weak connections, Secondary connections, Core connections, management collaboration, management access, teamwork concentration, cross-level collaboration, response time, collaborator proximity, communications worker, network elasticity, behavioral elasticity, and knowledge-transfer speed.

11. The method of claim 1 wherein the behavioral indicators include at least one of: work-life, exploration, social support, support network, efficiency, alignment, meeting culture, virtual impact, flexibility, and organizational flatness.

12. The method of claim 1 wherein the organization characteristics include at least one of:
engagement, productivity, and adaptability.

13. The method of claim 1 further comprising:
comparing the health score to a threshold; and
sending an alert to a user based on results of the comparing.

14. An organization monitoring system, the system comprising:
a processor; and
a memory with computer code instructions stored thereon, the processor and the memory, with the computer code instructions, being configured to cause the system to:
aggregate, in a database, time allocation data and attention minutes data for a plurality of people at a plurality of organizations;
process the aggregated time allocation data and attention minutes data from the database to determine a respective benchmark value for each of a plurality of objective measures;
receive time allocation data and attention minutes data for members of a given organization;
for each member in a subset of the members of the given organization, score behavioral indicators for the member by:
processing the received time allocation data and attention minutes data to determine a value for each of the plurality of objective measures for the member;
assigning a metric score for the member for each of the plurality of objective measures by comparing the determined value for each of the plurality of objective measures to the determined respective benchmark value for each of the plurality of objective measures; and
aggregating one or more assigned metric scores to determine a respective score for each of a plurality of behavioral indicators for the member;
aggregate one or more of the respective scores for the plurality of behavioral indicators for the members in the subset to determine a respective score for each of a plurality of organization characteristics for the given organization; and
process the respective scores for each of the plurality of organization characteristics to create a health score for the given organization.

15. The system of claim 14 wherein to process the aggregated time allocation data and attention minutes data, the processor and the memory, with the computer code instructions, are further configured to cause the system to:
exclude a subset of the aggregated data in determining the respective benchmark value for each of the plurality of objective measures.

16. The system of claim 15 wherein the processor and the memory, with the computer code instructions, are further configured to cause the system to exclude the subset of the aggregated data based upon at least one of:
a length of time over which data in the subset was collected; and
characteristics of a person associated with data in the subset.

17. The system of claim 14 wherein the processor and the memory, with the computer code instructions, are further configured to cause the system to:
determine each member in the subset of the members of the given organization based upon at least one of:
a length of time for which data associated with a member exists; and
characteristics of a member.

18. The system of claim 14 wherein to aggregate the one or more assigned metric scores to determine a respective score for each of a plurality of behavioral indicators, the processor and the memory, with the computer code instructions, are further configured to cause the system to:
for a given behavioral indicator, process the one or more assigned metric scores using a function specific to the given behavioral indicator to determine the respective score.

19. The system of claim 14 wherein the processor and the memory, with the computer code instructions, are further configured to cause the system to:
compare the health score to a threshold; and
send an alert to a user based on results of the comparing.

20. A computer program product for monitoring an organization, the computer program product comprising:
one or more non-transitory computer-readable storage devices and program instructions stored on at least one of the one or more storage devices, the program instructions, when loaded and executed by a processor, cause an apparatus associated with the processor to:
aggregate, in a database, time allocation data and attention minutes data for a plurality of people at a plurality of organizations;
process the aggregated time allocation data and attention minutes data from the database to determine a respective benchmark value for each of a plurality of objective measures;
receive time allocation data and attention minutes data for members of a given organization;
for each member in a subset of the members of the given organization, score behavioral indicators for the member by:
processing the received time allocation data and attention minutes data to determine a value for each of the plurality of objective measures for the member;
assigning a metric score for the member for each of the plurality of objective measures by comparing the determined value for each of the plurality of objective measures to the determined respective benchmark value for each of the plurality of objective measures; and
aggregating one or more assigned metric scores to determine a respective score for each of a plurality of behavioral indicators for the member;
aggregate one or more of the respective scores for the plurality of behavioral indicators for the members in the subset to determine a respective score for each of a plurality of organization characteristics for the given organization; and
process the respective scores for each of the plurality of organization characteristics to create a health score for the given organization.
